(19) United States
(12) Patent Application Publication
(10) Pub. No.: US 2022/0050323 A1
(43) Pub. Date: Feb. 17, 2022

(54) Liquid Crystal Display Component, Liquid Crystal Display Apparatus and Method for Manufacturing Liquid Crystal Display Component

(71) Applicants: K-Tronics (Suzhou) Technology Co., Ltd., Suzhou (CN); BOE Technology Group Co., Ltd., Beijing (CN)

(72) Inventors: Xiaoli XIA, Beijing (CN); Haowu XUE, Beijing (CN)

(21) Appl. No.: 17/210,531

(22) Filed: Mar. 24, 2021

(30) Foreign Application Priority Data
Aug. 13, 2020 (CN) 202010812693.X

(51) Int. Cl. G02F 1/1333; G02F 1/1335

(52) U.S. Cl. CPC G02F 1/133322; G02F 1/133325; G02F 1/133553; G02F 1/133504

(57) ABSTRACT

A liquid crystal display component, a liquid crystal display apparatus and a method for manufacturing the liquid crystal display component. The liquid crystal display component includes: a supporting frame, a liquid crystal panel, a back plate and a backlight component; wherein the supporting frame includes a frame body and a supporting platform, a first end of the frame body surrounds around the back plate and is connected with the back plate, a second end of the frame body extends to a middle part of the supporting frame to form the supporting platform, the liquid crystal panel is overlapped on a supporting surface of the supporting platform, a colloid layer is arranged between the supporting surface of the supporting platform and the liquid crystal panel, an accommodation space is formed between the liquid crystal panel and the back plate.

### CROSS-REFERENCE TO RELATED APPLICATION

The present application claims the priority of Chinese Patent Application No. 202010812693.X, filed to the CNIPA on Aug. 13, 2020, the content of which is hereby incorporated by reference.

### TECHNICAL FIELD

Embodiments of the present disclosure relate to, but are not limited to, the field of display device, and particularly relate to a liquid crystal display component, a liquid crystal display apparatus and a method for manufacturing the liquid crystal display component.

### BACKGROUND

Liquid crystal display screens are mainstream display screens at present, which have the advantages of mature production processes and relatively low prices, and are welcomed by the majority of users.

With the development of display technologies, display screens are developing towards narrow bezel. Because the narrow bezel display screen has a larger screen-to-body ratio and better viewing effects, users also prefer liquid display screens with narrow bezels.

However, in a structure of a current liquid display screen as shown in FIG. 1, a supporting part 11′ of a supporting frame 1′ is connected with a liquid panel 2′ through foam glue 3′. Due to existence of cutting tolerance of materials and manufacturing process tolerance of products and due to the fact that foam glue needs to have a certain width in order to ensure connection strength, the current liquid display screen cannot further achieve arrangement of a narrow bezel and cannot meet the needs of users.

### SUMMARY

The following is a summary of the subject matter described in detail in the present disclosure. This summary is not intended to limit the protection scope of the claims.

Embodiments of the present disclosure provide the following technical solution:

In one aspect, an embodiment of the present disclosure provides a liquid crystal display component including: a supporting frame, a liquid crystal panel, a back plate and a backlight component.

The supporting frame includes a frame body and a supporting platform. A first end of the frame body surrounds around the back plate and is connected with the back plate. A second end of the frame body extends to a middle part of the supporting frame to form the supporting platform. The liquid crystal panel is overlapped on a supporting surface of the supporting platform. A colloid layer is arranged between the supporting surface of the supporting platform and the liquid crystal panel. An accommodation space is formed between the liquid crystal panel and the back plate. The backlight component is arranged in the accommodation space and connected with the back plate.

In an exemplary embodiment, a width of the supporting platform from one side close to the middle part of the supporting frame to the frame body is greater than or equal to 0.5 mm and less than 1.2 mm.

In an exemplary embodiment, a distance between the supporting surface of the supporting platform and the second end of the frame body is equal to a thickness of the liquid crystal panel.

In an exemplary embodiment, a step is arranged between the supporting platform and the second end of the frame body, and a height of the step is equal to the thickness of the liquid crystal panel.

In an exemplary embodiment, the supporting surface of the supporting platform gradually inclines towards the first end of the frame body from one side close to the middle part of the supporting frame to the frame body.

In an exemplary embodiment, the included angle between the supporting surface of the supporting platform and the liquid crystal panel is greater than 0 degree and less than or equal to 50 degrees.

In an exemplary embodiment, the included angle between the supporting surface of the supporting platform and the liquid crystal panel is greater than 0 degree and less than or equal to 10 degrees.

In an exemplary embodiment, a first groove is arranged on one side of the supporting surface at a joint between the supporting platform and the frame body, and is configured to accommodate colloid for bonding the liquid crystal panel.

In an exemplary embodiment, the colloid is filled between the liquid crystal panel and the frame body.

In an exemplary embodiment, a second groove is arranged on one side opposite to the supporting surface at a joint between the supporting platform and the frame body.

In an exemplary embodiment, the second groove is an arc groove or a rounded corner which is concave towards the joint between the frame body and the supporting platform.

In an exemplary embodiment, a clamping part protrudes from one side opposite to the supporting surface of the supporting platform toward the first end of the frame body. A first clamping part is arranged at the first end of the frame body towards one side of the middle part of the supporting frame. A second clamping part is arranged at the back plate. The second clamping part is clamped with the first clamping part. An end of the back plate is limited between the frame body and the clamping part.

In an exemplary embodiment, the supporting frame is in shape of a rectangular ring.

The supporting frame includes a first part and a second part, wherein the first part has an integrated structure or the first part is formed by three line-shaped frames, the second part is a line-shaped frame, and an extension length of the supporting platform of the second part is greater than an extension length of the supporting platform of the first part.

In an exemplary embodiment, the backlight component includes an optical film. An plurality of lugs are arranged at intervals around an edge of the optical film. Hitch through holes are arranged on the lugs. A plurality of concaved areas are arranged at intervals around an end of the back plate. A bump is arranged in a middle part of each of the concaved areas. The lugs are accommodated in the concaved areas, and the bump is hitched to the respective hitch through hole.

In an exemplary embodiment, the backlight component includes the optical film, a diffusion plate and a reflection plate which are sequentially stacked, and lamp beads embedded in the reflection plate, wherein light from the lamp beads are directed to the diffusion plate.

In an exemplary embodiment, the first end of the frame body is located on one side close to the middle part of the supporting frame, and a guide angle is arranged from the first end of the frame body to the second end of the frame body.

In an exemplary embodiment, an angle of the guide angle is 15 degrees.

In another aspect, an embodiment of the present disclosure provides a liquid crystal display apparatus including a liquid crystal display component.

The liquid crystal display component includes: a supporting frame, a liquid crystal panel, a back plate and a backlight component.

The supporting frame includes a frame body and a supporting platform. A first end of the frame body surrounds around the back plate and is connected with the back plate. A second end of the frame body extends to a middle part of the supporting frame to form the supporting platform. The liquid crystal panel is glued to a supporting surface of the supporting platform. An accommodation space is formed between the liquid crystal panel and the back plate. The backlight component is arranged in the accommodation space and connected with the back plate.

In another aspect, an embodiment of the present disclosure provides a method for manufacturing the above-mentioned liquid crystal display component, including: positioning a supporting frame by using a mold, and performing a first time of dispensing on a supporting platform at a first end of the supporting frame; buckling the liquid crystal panel on the supporting platform and bonding the liquid crystal panel with the supporting platform; performing a second time of dispensing between the liquid crystal panel and a frame body of the supporting frame; and arranging a backlight component on a back plate, and connecting the back plate with a second end of the supporting frame.

In an exemplary embodiment, the method further includes: providing the supporting frame to be in shape of a rectangular ring and dividing the supporting frame into four line-shaped frames; and making one end of the supporting platform of each line-shaped frame of the supporting frame away from the frame body support abut against the mold, and pressing the line-shaped frame towards a middle part of the supporting frame to position the supporting frame.

The above description is only an overview of the technical solution of the present disclosure. In order to understand the technical means of the present disclosure more clearly and implement it according to the contents of the specification, the following detailed description will be made with the exemplary embodiments of the present disclosure in conjunction with the accompanying drawings.

Other aspects will become apparent upon reading and understanding accompanying drawings and the detailed description.

### BRIEF DESCRIPTION OF DRAWINGS

The above and other objects, features and advantages of exemplary embodiments of the present disclosure will become readily understood through reading the following detailed description with reference to the accompanying drawings. Several embodiments of the present disclosure are illustrated by way of example but not limitation in the accompanying drawings, in which like or corresponding reference numerals denote like or corresponding parts, and in which:

FIG. 1 schematically shows a structural diagram of a liquid crystal display component.

FIG. 2 schematically shows a structural diagram of a liquid crystal display component according to an embodiment of the present disclosure.

FIG. 3 schematically shows a structural diagram of hook connection between an optical film of a liquid crystal display component and a back plate according to an embodiment of the present disclosure.

FIG. 4 schematically shows a structural diagram of a supporting frame of a liquid crystal display component according to an embodiment of the present disclosure.

FIG. 5 schematically shows a structural diagram of a supporting frame of a liquid crystal display component according to an embodiment of the present disclosure;

FIG. 6 schematically shows a flow diagram of a method for manufacturing a liquid crystal display component according to an embodiment of the present disclosure.

FIG. 7 schematically shows a structural diagram of a supporting frame fixed by a mold and after bond on the supporting platform for a first time in a manufacturing process of a liquid crystal display component according to an embodiment of the present disclosure.

FIG. 8 schematically shows a structural diagram during gluing for a second time in a manufacturing process of a liquid crystal display component according to an embodiment of the present disclosure.

FIG. 9 schematically shows a structural diagram after gluing for a second time in the manufacturing process of a liquid crystal display component according to an embodiment of the present disclosure.

### DETAILED DESCRIPTION

Exemplary embodiments of the present disclosure will be described in more detail below with reference to the accompanying drawings. Although exemplary embodiments of the present disclosure are shown in the drawings, it should be understood that the present disclosure may be embodied in various forms and should not be limited by the embodiments set forth herein. On the contrary, these embodiments are provided to enable a more thorough understanding of the present disclosure and to fully convey the scope of the present disclosure to those skilled in the art. The following embodiments serve to illustrate the present disclosure, but are not intended to limit the scope of the present disclosure. It should be noted that the embodiments in the present disclosure and features in the embodiments may be combined with each other arbitrarily if there is no conflict.

It should be noted that, unless otherwise specified, the technical terms or scientific terms used in the present disclosure shall have general meanings understood by those skilled in the art to which the present disclosure belongs.

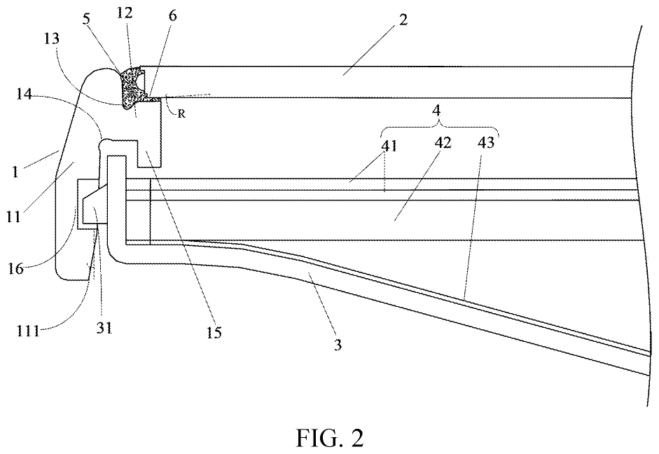

As shown in FIG. 2, a liquid crystal display component proposed by an embodiment of the present disclosure includes a supporting frame 1, a liquid crystal panel 2, a back plate 3, and a backlight component 4. The supporting frame 1 includes a frame body 11 and a supporting platform 12, wherein a first end of the frame body 11 surrounds around the back plate 3 and is connected with the back plate 3. A second end of the frame body 11 extends to a middle part of the supporting frame 1 to form the supporting platform 12. The liquid crystal panel 2 rests on a supporting surface of the supporting platform 12. A colloid layer 6 is arranged between the supporting surface of the supporting platform 12 and the liquid crystal panel 2. An accommodation space is formed between the liquid crystal panel 2 and the back plate 3. The backlight component 4 is arranged in the accommodation space and connected with the back plate 3.

In an exemplary embodiment, in order to enable the liquid crystal display component to emit light normally for display, a relative positional relation between the liquid crystal panel 2, the back plate 3 and the backlight component 4 in the liquid crystal display component is known to those skilled in the art, that is, an order of the above-mentioned liquid crystal panel 2, the backlight component 4 and the back plate 3 may be in a stacked arrangement. The backlight component 4 may include an optical film 41, a diffusion plate 42, a reflection plate 43, and lamp beads embedded in the reflection plate 43 which are sequentially arranged in a stacked manner, wherein light from the lamp beads is directed to the diffusion plate 42.

In an exemplary embodiment, the supporting frame 1 is a frame forming a ring, which may be a rectangular ring or a circular ring. The supporting frame 1 is used for mounting and fixing the liquid crystal panel 2, the back plate 3 and the backlight component 4, and is used for maintaining the relative positional relation between the liquid crystal panel 2, the back plate 3 and the backlight component 4, and for forming a relatively sealed space together with the liquid crystal panel 2 and the back plate 3. That is, the supporting frame 1 closes around an accommodation space formed between the liquid crystal panel 2 and the back plate 3 to form the sealed space, so that in the accommodation space the backlight component 4 may avoid intrusion of the dust, thus preventing entering dust from affecting the display effect. The frame body 11 of the supporting frame 1 is a supporting body surrounding around the back plate 3, wherein a cross-section of the frame body may be strip-shaped or may be designed according to the structural requirements of products. The frame body 11 of the supporting frame 1 and the supporting platform 12 may be integrally formed, for example, integrally formed by injection molding or extrusion. The cross-sectional shape of the supporting platform 12 is not limited, as long as the supporting platform 12 has a supporting surface capable of supporting the liquid crystal panel 2. The supporting surface may be a flat surface and have a certain angle with respect to the liquid crystal display panel, or may be a supporting surface with a colloid groove. As for the colloid layer 6 between the supporting platform 12 and the liquid crystal panel 2, the colloid layer 6 may be formed by dispensing glue on the supporting surface of the supporting platform 12 in advance by a dispensing process, and then the liquid crystal panel 2 is overlapped onto the supporting surface to make it contact with the colloid layer 6 to realize a gluing connection. A connection between the first end of the frame body 11 and the back plate 3 may be a clamping connection or a gluing connection. In order to ensure performance of convenient assembly, the frame body 11 and the back plate 3 may be in transition fit.

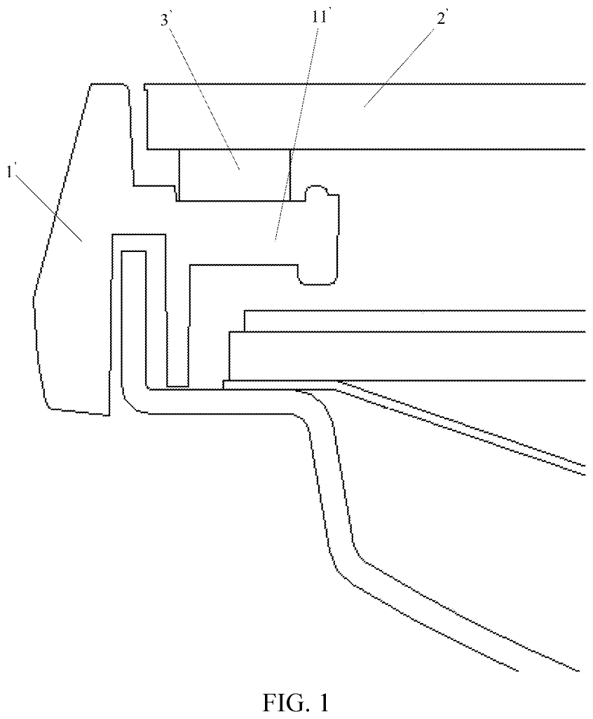

In the liquid crystal display component according to the embodiment of the present disclosure, the first end of the frame body 11 of the supporting frame 1 surrounds around the back plate 3 and is connected with the back plate 3, and the supporting platform 12 is convexly arranged at the second end of the frame body 11 and the supporting platform 12 is connected with the liquid crystal panel 2 by arranging the colloid layer 6. As shown in FIG. 1, the liquid crystal panel 2′ is connected with the supporting frame 1′ by foam glue 3′. Because the foam glue 3′ is too narrow, adhesive strength of the foam glue 3′ is insufficient to bond the liquid crystal panel 2′ and the supporting frame 1′ stably. If the foam glue 3′ is too narrow, it is difficult to grasp, which makes it difficult to perform an operation of sticking the foam glue 3′ on the supporting frame 1′, thus automation cannot be achieved The foam glue 3′ is too narrow to perform manual sticking. Furthermore, cutting of the foam glue 3′ in a width direction has a certain tolerance, so that it is impossible to bond the liquid crystal panel 2′ and the supporting frame 1′ by using the narrow foam glue 3′, therefore it is necessary to use foam glue 3′ with a certain width and match a width of the supporting part 11′ of the supporting frame 1′ with the width of the foam glue 3′. In addition, in order to limit the foam glue 3′ and prevent the foam glue 3′ from extending in a direction into a middle part of the supporting frame 1′ to block a display area of the liquid panel 2′ when the foam glue 3′ is stuck with the supporting part 11′ of the supporting frame 1′, it is necessary to arrange a groove in the supporting part 11′ of the supporting frame 1′ which is used for limiting the foam glue 3′. However, since the width of the supporting part 11′ cannot be equal to or less than a width of the groove due to arrangement of the groove, the width of the supporting part 11′ needs to be greater than the width of the foam glue 3′, which causes the supporting part 11′ of the supporting frame 1′ to extend too far into a orthographic projection area of the liquid crystal panel 2′, that is, a narrow bezel cannot be realized. In the embodiment of the present disclosure, the supporting frame 1 and the liquid crystal panel 2 are bonded by using the colloid layer 6. Since the colloid layer 6 may be formed by dispensing, a width of the colloid layer 6 may be accurately controlled by accurately controlling amount of glue dispensed by a dispensing machine, and the adhesive strength between the liquid crystal panel 2 and the supporting frame 1 may be met by a narrow colloid layer 6. Therefore the colloid layer 6 may be provided to be narrower than the foam glue. In addition, the colloid layer 6 may be directly formed by gluing on the supporting surface of the supporting platform 12 without arranging a groove on the supporting platform 12 of the supporting frame 1, then the supporting platform 12 may be made narrower by bonding the liquid crystal panel 2 and the supporting frame 1 using the colloid layer 6, that is, a distance by which the supporting platform 12 extends to the middle part of the supporting frame 1 is small, and a distance by which the supporting platform 12 extends into the orthographic projection area of the liquid crystal panel 2 is small, thus making the contact width between the liquid crystal panel 2 and the supporting platform 12 small so as to achieve an effect of narrow bezel of the liquid crystal display component.

In an exemplary embodiment, the narrowest width of the foam glue needs to be greater than or equal to 1.2 mm due to requirements of manufacturing processes of the foam glue and adhering of the foam glue. Therefore, if the liquid crystal panel 2 and the supporting frame 1 are connected with each other using the foam glue, the supporting platform 12 of the supporting frame 1 cannot be made narrower, that is, the effect of narrow bezel cannot be achieved. In the embodiment of the present disclosure, the supporting frame 1 and the liquid crystal panel 2 are connected with each other using the colloid layer 6, since the colloid layer may be formed narrower, the width of the supporting platform 12 from one side close to the middle part of the supporting frame 1 to the frame body 11 is provided to be greater than or equal to 0.5 mm and less than 1.2 mm in the embodiment of the present disclosure. Compared with use of the foam glue, the use of the colloid layer 6 in the embodiment of the present disclosure can achieve the effect of narrow bezel.

In an exemplary embodiment, a distance between the supporting surface of the supporting platform 12 and the second end of the frame body 11 is equal to a thickness of the liquid crystal panel 2.

In an exemplary embodiment, a step is formed between the supporting platform 12 and the second end of the frame body 11, wherein a height of the step is equal to the thickness of the liquid crystal panel 2. In this way, when the liquid crystal panel 2 is overlapped and bonded on the supporting platform 12, the liquid crystal panel 2 is flush with the second end of the frame body 11, and the formed liquid crystal display component has a flush light exiting surface for display, which is convenient for subsequent work such as closing the cover plate or packaging.

In an exemplary embodiment, the liquid crystal panel 2 is connected with the supporting surface of the supporting platform 12 with glue, and the glue needs to be dispensed on the supporting surface of the supporting platform 12 in advance during the production process. Therefore, in order to prevent the glue from flowing out from the supporting surface of the supporting platform 12, an included angle R between the supporting surface of the supporting platform 12 and the liquid crystal panel 2 may be set to be greater than 0 degree and less than or equal to 50 degrees, that is, the supporting surface of the supporting platform 12 inclines towards the frame body 11 by the above angle. The angle R between the supporting surface of the supporting platform 12 and the liquid crystal panel 2 may be greater than 0 degree and less than or equal to 10 degrees.

In an exemplary embodiment, a first groove 13 is arranged on one side of the supporting surface at a joint between the supporting platform 12 and the frame body 11, and the first groove is used for accommodating colloid 5 for bonding the liquid crystal panel 2.

In an exemplary embodiment, as mentioned above, it is necessary to dispense glue on the supporting surface of the supporting platform 12 in advance before bonding the liquid crystal panel 2 and the supporting platform 12. Therefore, in order to better ensure that the glue will not overflow, the first groove 13 may be arranged on one side of the supporting surface at the joint between the supporting platform 12 and the frame body 11. The first groove 13 is a glue overflow groove, wherein a shape of the first groove 13 may be arc-shaped.

In an exemplary embodiment, the colloid 5 is filled between the liquid crystal panel 2 and the frame body 11.

In an exemplary embodiment, by arranging the colloid layer 6 between the liquid crystal panel 2 and the supporting surface of the supporting platform 12, and arranging the colloid between the liquid crystal panel 2 and the frame body 11 as well, the liquid crystal panel 2 may be effectively fixed and the adhesive strength may be effectively increased. The colloid layer 6 arranged between the liquid crystal panel 2 and the supporting surface of the supporting platform 12 may be formed after a first time of dispensing. The colloid may also be arranged between the liquid crystal panel 2 and the frame body 11. After the first time of dispensing, a second time of dispensing may be performed between the liquid crystal panel 2 and the frame body 11 after the liquid crystal panel 2 is overlapped on the supporting surface and bonded with the colloid layer 6 after the first time of dispensing.

In an exemplary embodiment, a second groove 14 is arranged on one side opposite to the supporting surface at the joint between the supporting platform 12 and the frame body 11 .

In an exemplary embodiment, the frame body 11 and the back plate 3 may be in transition fit, so the arrangement of the second groove 14 may disperse the stress caused by interference fit, wherein the second groove 14 may be an arc groove or a rounded corner concaved toward the joint between the frame body 11 and the supporting platform 12.

In an exemplary embodiment, a clamping part 15 protrudes from the side opposite to the supporting surface of the supporting platform 12 toward the first end of the frame body 11. A first clamping part 16 is arranged at the first end of the frame body 11 toward the middle part of the supporting frame 1. A second clamping part 31 is arranged at the back plate 3. The first clamping part 16 is clamped with the second clamping part 31. An end of the back plate 3 is limited between the frame body 11 and the clamping part 15.

In an exemplary embodiment, due to the clamping between the back plate 3 and the frame body 11, space formed between the clamping part 15 and the frame body 11 may allow the end of the back plate 3 to extend therein. At this time, the clamping part 15 may limit the back plate 3 to a certain extent, so that the back plate 3 and the frame body 11 may be clamped with each other stably. The first clamping part 16 may be a clamping groove, and the second clamping part 31 may be a clamping block. Optionally, the first clamping part 16 and the second clamping part 31 may be interchanged, as long as it is ensured that the first clamping part 16 may be stably clamped with the second clamping part 31.

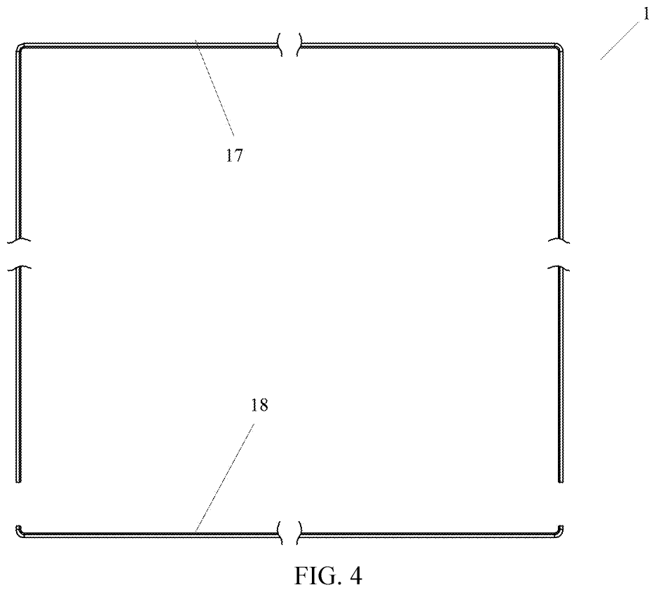

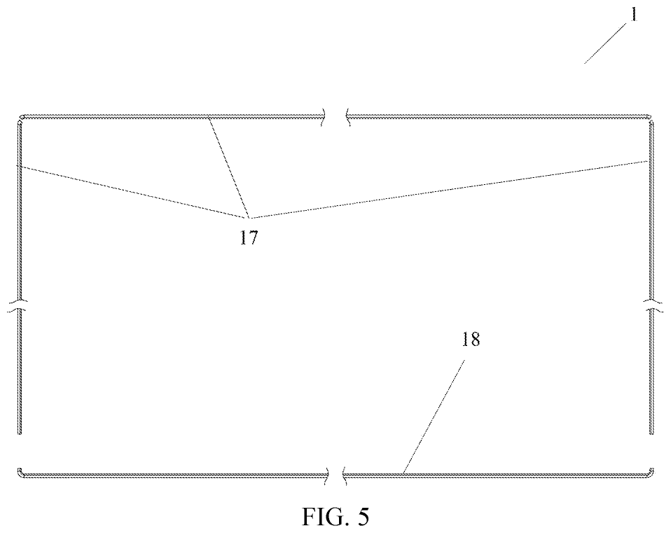

In an exemplary embodiment, the supporting frame 1 is in shape of a rectangular ring. As shown in FIG. 4, the supporting frame 1 may include two parts, a first part 17 is adjacent three side frames of the supporting frame 1 in shape of a rectangular ring which are connected together and the first part is a U-shaped frame as a whole, and the second part 18 is a line-shaped frame. At this time, the supporting platform 12 of the first part 17 of the supporting frame 1 is connected with the liquid crystal panel 2 by colloid. The supporting platform 12 of the second part 18 of the supporting frame 1 may be bonded with the liquid crystal panel 2 by colloid or form glue. An extension length of the supporting platform 12 of the second part 18 is greater than an extension length of the supporting platform 12 of the first part 17. Alternatively, as shown in FIG. 5, the supporting frame 1 in shape of rectangular ring may be formed by four parts of line-shaped frames, that is, the first part 17 may be formed by three line-shaped frames.

In an exemplary embodiment, because rectangular liquid crystal display components are commonly used, when the liquid crystal display component is rectangular, it is necessary to correspondingly provide the supporting frame 1 to be in shape of a rectangular ring. At this time, the four side frames of the supporting frame 1 may be formed by two parts or four parts. When the supporting frame 1 is formed by two parts, as mentioned above, the first part includes frames with three adjacent sides and is a U-shaped frame as a whole, and the second part is a line-shaped frame. At this time, the structure of the three frames of the first part may be completely the same as the structure of the second part, or the extension length of the supporting platform 12 of the line-shaped frame of the second part may be set to be relatively longer. So that the U-shaped frame of the first part may respectively correspond to three sides of the liquid crystal panel 2 where no driving circuit is arranged, while the line-shaped frame of the second part corresponds to one side of the liquid crystal panel 2 where a driving circuit is arranged. Similarly, when the supporting frame 1 is formed by four parts, all the four parts are line-shaped frames which may have the same structure. Or, as mentioned above, the three adjacent line-shaped frames have the same structure and correspond to the three sides of the liquid crystal panel 2 where no driving circuit is arranged, and an extension length of the supporting platform 12 of the other line-shaped frame is greater than an extension length of the supporting platform 12 of the other three line-shaped frames, and the line-shaped frame corresponds to the side of the liquid crystal panel 2 where the driving circuit is arranged.

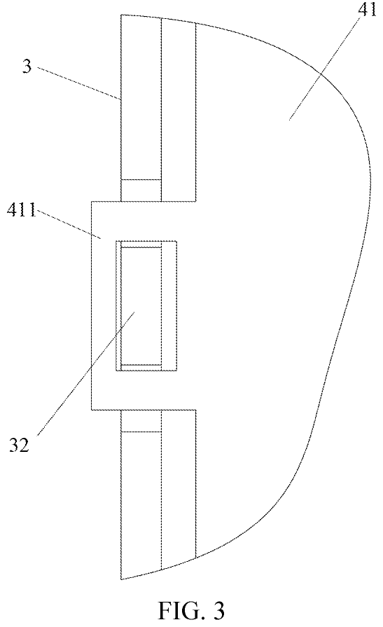

As shown in FIG. 3, in an exemplary embodiment, the backlight component 4 includes an optical film 41. A plurality of lugs 411 are arranged at intervals around the periphery of an edge of the optical film 41. Hitch through holes are arranged on the lugs 411. A plurality of concaved areas are arranged at intervals around an end of the periphery of the back plate 3. A bump 32 is arranged in a middle part of each of the concaved areas. The lugs 411 are accommodated in the concaved areas. The bump 32 is hitched to the hitch through hole.

In an exemplary embodiment, since the supporting platform 12 of the liquid crystal display component according to the embodiment of the present disclosure is bonded with the liquid crystal panel 2, an extension length of the supporting platform 12 is short, that is, the liquid crystal display component has a narrow bezel. At this time, it is necessary to ensure that a gap between the optical film 41 and the back plate 3 is located within a range of the orthographic projection of the narrow bezel. Therefore, a lug 411 having a hitch through hole is arranged at an edge of the optical film 41 and hitched to the bump 32 at the end of the back plate 3. A certain tensile force may be generated in a process of forming and shrinking the optical film 41, so as to avoid a large gap between the optical film 41 and the back plate 3, and further ensure that light emitted by the backlight component 4 will generate no black edge on the edges of the liquid crystal display component.

In an exemplary embodiment, the first end of the frame body 11 is located on one side close to the middle part of the supporting frame, and a guide angle 111 is arranged from the first end of the frame body 11 to the second end of the frame body 11.

In an exemplary embodiment, an angle of the guide angle 111 may be, for example, 15 degrees. The arrangement of the guide angle 111 may facilitate the connection between the back plate 3 and the supporting frame 1, that is, when the back plate 3 is matched with the supporting frame 1, the guide angle 111 may serve a function of guiding the back plate 3.

Another embodiment of the present disclosure provides a liquid crystal display apparatus, which includes a liquid crystal display component as shown in FIG. 2. The liquid crystal display component includes a supporting frame 1, a liquid crystal panel 2, a back plate 3 and a backlight component 4. The supporting frame 1 includes a frame body 11 and a supporting platform 12. A first end of the frame body 11 surrounds around the back plate 3 and is connected with the back plate 3. A second end of the frame body 11 extends to a middle part of the supporting frame 1 to form the supporting platform 12. The liquid crystal panel 2 is overlapped on a supporting surface of the supporting platform 12. A colloid layer 6 is arranged between the supporting surface of the supporting platform 12 and the liquid crystal panel 2. An accommodation space is formed between the liquid crystal panel 2 and the back plate 3. And the backlight component 4 is arranged in the accommodation space and connected with the back plate 3.

In an exemplary embodiment, the liquid crystal display component may directly use the liquid crystal display component according to the above-mentioned embodiment, and the implementation structure of the liquid crystal display component may be referred to the related contents described in the above-mentioned embodiment, which will not be repeated here.

In the liquid crystal display component according to the embodiment of the present disclosure, the first end of the frame body 11 of the supporting frame 1 surrounds around the back plate 3 and is connected with the back plate 3, the supporting platform 12 is convexly arranged at the second end of the frame body 11, and the supporting platform 12 is connected with the liquid crystal panel 2 by arranging the colloid layer 6. Compared with what is shown in FIG. 1, the liquid crystal panel 2′ is connected with the supporting frame 1′ by foam glue 3′. Because the foam glue 3′ is too narrow, adhesive strength of the foam glue 3′ is insufficient to bond the liquid crystal panel 2′ and the supporting frame 1′ stably. If the foam glue 3′ is too narrow, it is difficult to grasp, which makes it difficult to perform an operation of sticking the foam glue 3′ on the supporting frame 1′, thus automation cannot be achieved, and manual sticking of the too narrow foam glue 3′ cannot be performed. Furthermore, cutting of the foam glue 3′ in a width direction has a certain tolerance, so that it is impossible to bond the liquid crystal panel 2′ and the supporting frame 1′ by using the narrow foam glue 3′, and it is necessary to use foam glue 3′ with a certain width and match a width of the supporting part 11′ of the supporting frame 1′ with the width of the foam glue 3′. In addition, in order to limit the foam glue 3′ and prevent the foam glue 3′ from extending in a direction in a middle part of the supporting frame 1′ to block a display area of the liquid panel 2′ when the foam glue 3′ is stuck with the supporting part 11′ of the supporting frame 1′, it is necessary to arrange a groove for limiting the foam glue 3′ in the supporting part 11′ of the supporting frame 1′. But the width of the supporting part 11′ cannot be equal to or less than a width of the foam glue 3′ due to arrangement of the groove. The width of the supporting part 11′ needs to be greater than the width of the foam glue 3′, which causes the supporting part 11′ of the supporting frame 1′ to extend too far into an orthographic projection area of the liquid crystal panel 2′, that is, a narrow bezel cannot be realized. In an embodiment of the present disclosure, the supporting frame 1 and the liquid crystal panel 2 are bonded by using the colloid layer 6. Since the colloid layer 6 may be formed by dispensing, a width of the colloid layer 6 may be accurately controlled by controlling amount of glue dispensed through a dispensing machine. The adhesive strength between the liquid crystal panel 2 and the supporting frame 1 may be met by a narrow colloid layer 6, so the colloid layer 6 may be provided to be narrower than the foam glue. In addition, the colloid layer 6 may be directly formed by gluing on the supporting surface of the supporting platform 12 without arranging a groove on the supporting platform 12 of the supporting frame 1. The supporting platform 12 may be made narrower by bonding the liquid crystal panel 2 and the supporting frame 1 using the colloid layer 6, that is, a distance by which the supporting platform 12 extends to the middle part of the supporting frame 1 is small, and a distance by which the supporting platform 12 extends into the orthographic projection area of the liquid crystal panel 2 is small, thus making a contact width between the liquid crystal panel 2 and the supporting platform 12 small, and the effect of narrow bezel of the liquid crystal display component is achieved.

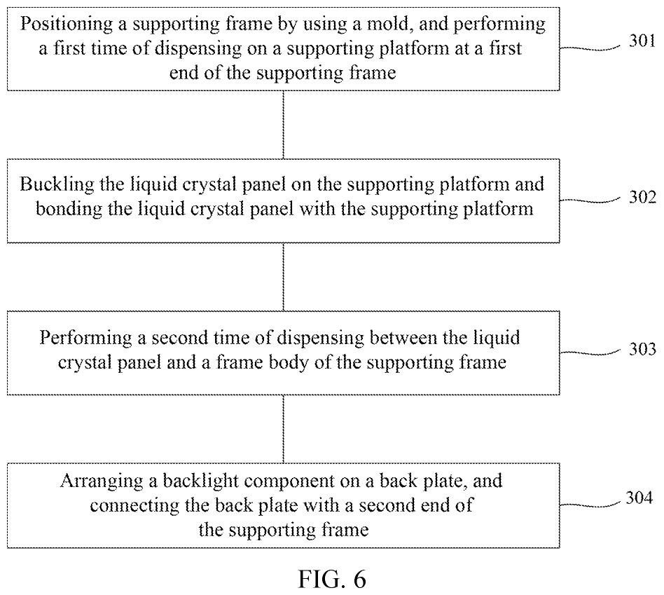

Another embodiment of the present disclosure provides a method for manufacturing a liquid crystal display component, which is used for manufacturing the liquid crystal display component according to the above embodiment, and includes steps 301-304 as shown in FIG. 6.

Step 301 includes: positioning a supporting frame by using a mold, and performing a first time of dispensing on a supporting platform at a first end of the supporting frame.

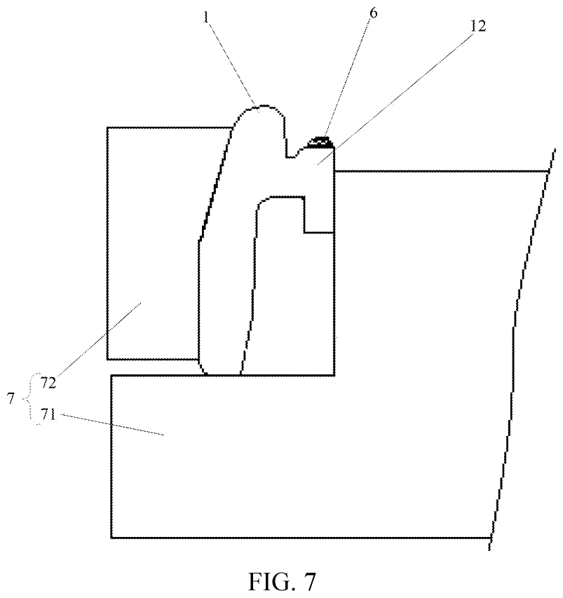

In an exemplary embodiment, a mold 7 is used for positioning the supporting frame, which is arranged by a skilled person according to the structure of the supporting frame. For example, as shown in FIG. 7, the mold may be divided into two parts. A first part 71 of the mold is placed in a space enclosed by the supporting frame to position a middle part space enclosed by the supporting frame and abuts against an extension end of the supporting platform of the supporting frame. A second part 72 of the mold presses outside of the supporting frame and presses against the first part 71 of the mold, so that size accuracy of a ring enclosed by the supporting frame may be limited by the mold, and the first time of dispensing is performed on the supporting platform to form a colloid layer 6. In this way, the mold 7 is used to pre-position and then bond the liquid crystal panel 2, which ensures a matching accuracy between the supporting frame 1 and the liquid crystal panel 2, and ensures that the matching accuracy may be within a minimum range of matching tolerance, thereby avoiding increase of the frame width caused by the assembly tolerance, and making the supporting frame 1 and the liquid crystal panel 2 have a good effect of narrow bezel after being assembled.

Step 302 includes: buckling the liquid crystal panel on the supporting platform and bonding the liquid crystal panel with the supporting platform.

In an exemplary embodiment, this process may be completed by an automated machine. For example, a robot or an automated arm holds the liquid crystal panel by suction, buckles the liquid crystal panel onto the supporting platform, and bonds the liquid crystal panel with the colloid layer.

Step 303 includes: performing a second time of dispensing between the liquid crystal panel and a frame body of the supporting frame.

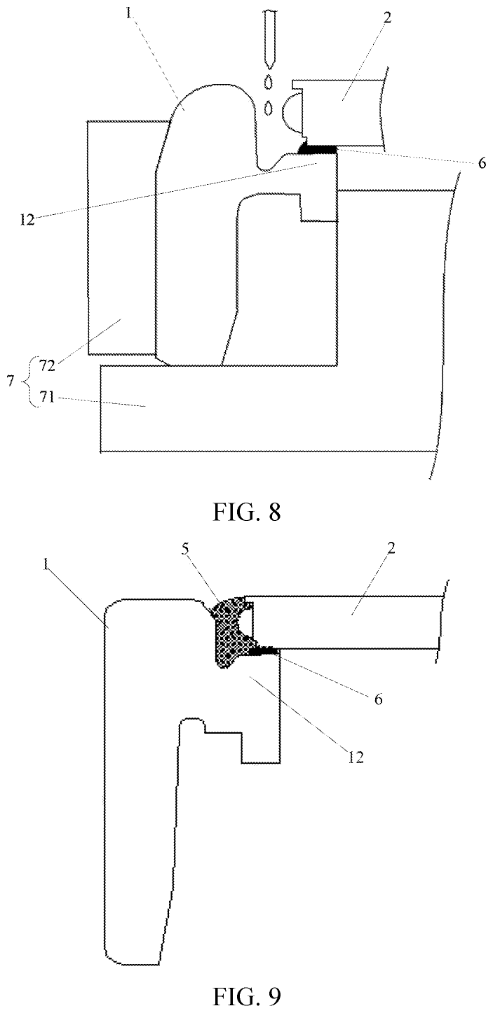

In an exemplary embodiment, as shown in FIG. 8 and FIG. 9, after the liquid crystal panel 2 is bonded with the colloid layer 6 on the supporting platform 12, a gap between the frame body of the supporting frame 1 and the liquid crystal panel 2 may be glued for the second time, that is, the second time of dispensing. The connection strength between the supporting frame 1 and the liquid crystal panel 2 is further strengthened.

Step 304 includes: arranging a backlight component on a back plate, and connecting the back plate with a second end of the supporting frame.

In an exemplary embodiment, a structure after the back plate is finally installed is shown in FIG. 2. After a connection between the liquid crystal panel 2 and the supporting frame 1 is completed, whether the supporting frame is the above-mentioned two-part supporting frame or four-part supporting frame, a size of the rectangular space enclosed by a middle part of the supporting frame has been limited. The back plate is connected at last. An assembly tolerance between the back plate and the supporting frame will not affect assembly between the liquid crystal panel and the supporting frame, thus avoiding excessive introduction of matching tolerance between the back plate and the supporting frame, that is, avoiding increasing the tolerance when the supporting frame is matched with the liquid crystal panel because the back plate and the supporting frame are assembled first, so as to further ensure the effect of narrow bezel after the connection between the supporting frame and the liquid crystal panel is completed.

For the above manufacturing method, the second time of dispensing and the connection between the back plate and the supporting frame may be exchanged in sequence, which will not affect the finished product quality of the liquid crystal display component.

In an exemplary embodiment, the supporting frame may be configured in the form of a four-part supporting frame as described in the above embodiment. As shown in FIG. 7, when the supporting frame is positioned by the mold 7 before being connected with the liquid crystal panel in step 301, ends of extension ends of the supporting platforms 12 of the four line-shaped frames may be respectively against the first part 71 of the mold located in the middle part of the supporting frame 1, and then the four line-shaped frames are pressed toward the first part 71 of the mold by the second part 72 of the mold located outside the supporting frame 1, making the four line-shaped frames flat against the first part 71 of the mold. Because the mold 7 may be processed very precisely and the four line-shaped frames are free from each other, a size of length and width of middle part space of the supporting frame 1 enclosed by the four line-shaped frames may be equal to a size of the first part 71 of the mold under positioning the four line-shaped frames by the first part 71 of the mold and the second part 72 of the mold, that is, tolerance of the length and the width of the middle part space of the supporting frame 1 may be allowed to be very small or even zero. In this way, when the liquid crystal panel 2 is connected with the supporting frame 1, the matching tolerance between the liquid crystal panel 2 and the supporting frame 1 will also be very small. A distance by which the supporting platform 12 extends to an orthographic projection area of the liquid crystal panel 2 may be minimized, thus ensuring the effect of narrow bezel after the liquid crystal panel 2 is matched with the supporting frame 1.

In summary, in the liquid crystal display component according to the embodiment of the disclosure, the first end of the frame body of the supporting frame surrounds around the back plate and is connected with the back plate, the second end of the frame body is convexly arranged at the supporting platform, and the supporting platform is connected with the liquid crystal panel by arranging the colloid layer. Compared with the prior art, in which the liquid crystal panel is connected with the supporting frame by foam glue, because the foam glue is too narrow, the adhesive strength of the foam glue is insufficient to bond the liquid crystal panel and the supporting frame stably. If the foam glue is too narrow, it is difficult to grasp, which makes it difficult to perform the operation of sticking the foam glue on the supporting frame, and automation cannot be achieved. Manual sticking of the too narrow foam glue cannot be performed. Furthermore, the cutting of the foam glue in a width direction has a certain tolerance, so that it is impossible to bond the liquid crystal panel and the supporting frame by using the narrow foam glue, and it is necessary to use foam glue with a certain width and match the width of the supporting part of the supporting frame with the width of the foam glue. In addition, in order to limit the foam glue and prevent the foam glue from extending into a middle part direction of the supporting frame to block the display area of the liquid panel when the foam glue is stuck with the supporting part of the supporting frame, it is necessary to arrange the groove for limiting the foam glue in the supporting part of the supporting frame. However, the width of the supporting part cannot be equal to or less than the width of the groove due to arrangement of the groove. The width of the supporting part needs to be greater than the width of the foam glue, which in summary causes the supporting part of the supporting frame to extend too far into the orthographic projection area of the liquid crystal panel, that is, a narrow bezel cannot be achieved. In the embodiment of the present disclosure, the supporting frame and the liquid crystal panel are bonded by using the colloid layer. Since the colloid layer may be formed by dispensing, the width of the colloid layer may be accurately controlled by controlling amount of glue dispensed through a dispensing machine. The adhesive strength between the liquid crystal panel and the supporting frame may be met by a narrow colloid layer, so the colloid layer may be provided to be narrower than the foam glue. In addition, the colloid layer may be directly formed by gluing on the supporting surface of the supporting platform without arranging the groove on the supporting platform of the supporting frame. Further, the supporting platform may be made narrower by bonding the liquid crystal panel and the supporting frame using the colloid layer, that is, a distance by which the supporting platform extends toward the middle part of the supporting frame is small, and a distance by which the supporting platform extends into the orthographic projection area of the liquid crystal panel is small, thus making the contact width between the liquid crystal panel and the supporting platform small and the effect of narrow bezel of the liquid crystal display component is achieved.

It may be understood that the relevant features in the above devices may be referred to each other. In addition, “first”, “second”, etc. in the above embodiments are used to distinguish embodiments, and do not represent the advantages and disadvantages of the embodiments.

In the specification provided herein, a great number of details are described. However, it may be understood that embodiments of the present disclosure may be practiced without these details. In some instances, well-known structures and techniques have not been shown in detail so as not to obscure the understanding of this specification.

The above is only the specific embodiment of the present disclosure, but the protection scope of the present disclosure is not limited to this. Any person familiar with this technical field may easily conceive changes or substitutions within the technical scope disclosed in the present disclosure, which should be covered within the protection scope of the present disclosure. Therefore, the protection scope of the present disclosure shall be subject to the protection scope of the claims.

What is claimed is:

1. A liquid crystal display component, comprising: a supporting frame, a liquid crystal panel, a back plate and a backlight component; wherein
the supporting frame comprises a frame body and a supporting platform, a first end of the frame body surrounds around the back plate and is connected with the back plate, a second end of the frame body extends to a middle part of the supporting frame to form the supporting platform, the liquid crystal panel is overlapped on a supporting surface of the supporting platform, a colloid layer is arranged between the supporting surface of the supporting platform and the liquid crystal panel, an accommodation space is formed between the liquid crystal panel and the back plate, and the backlight component is arranged in the accommodation space and connected with the back plate.

2. The liquid crystal display component according to claim 1, wherein a width of the supporting platform from one side close to the middle part of the supporting frame to the frame body is greater than or equal to 0.5 mm and less than 1.2 mm.

3. The liquid crystal display component according to claim 1, wherein a distance between the supporting surface of the supporting platform and the second end of the frame body is equal to a thickness of the liquid crystal panel.

4. The liquid crystal display component according to claim 3, wherein a step is arranged between the supporting platform and the second end of the frame body, and a height of the step is equal to the thickness of the liquid crystal panel.

5. The liquid crystal display component according to claim 3, wherein the supporting surface of the supporting platform gradually inclines towards the first end of the frame body from one side close to the middle part of the supporting frame to the frame body, and an included angle of more than 0 degree and less than or equal to 50 degrees is formed between the supporting surface of the supporting platform and the liquid crystal panel.

6. The liquid crystal display component according to claim 5, wherein the included angle between the supporting surface of the supporting platform and the liquid crystal panel is greater than 0 degree and less than or equal to 50 degrees.

7. The liquid crystal display component according to claim 6, wherein the included angle between the supporting surface of the supporting platform and the liquid crystal panel is greater than 0 degree and less than or equal to 10 degrees.

8. The liquid crystal display component according to claim 3, wherein a first groove is arranged on one side of the supporting surface at a joint between the supporting platform and the frame body, and is configured to accommodate colloid for bonding the liquid crystal panel.

9. The liquid crystal display component according to claim 8, wherein the colloid is filled between the liquid crystal panel and the frame body.

10. The liquid crystal display component according to claim 3, wherein a second groove is arranged on one side opposite to the supporting surface at a joint between the supporting platform and the frame body.

11. The liquid crystal display component according to claim 10, wherein the second groove is an arc groove or a rounded corner which is concave towards the joint between the frame body and the supporting platform.

12. The liquid crystal display component according to claim 1, wherein a clamping part protrudes from one side opposite to the supporting surface of the supporting platform toward the first end of the frame body, a first clamping part is arranged at the first end of the frame body towards one side of the middle part of the supporting frame, a second clamping part is arranged at the back plate, the second clamping part is clamped with the first clamping part, and an end of the back plate is limited between the frame body and the clamping part.

13. The liquid crystal display component according to claim 1, wherein
the supporting frame is in shape of a rectangular ring; and
the supporting frame comprises a first part and a second part, wherein the first part has an integrated structure or the first part is formed by three line-shaped frames, the second part is a line-shaped frame, and an extension length of the supporting platform of the second part is greater than an extension length of the supporting platform of the first part.

14. The liquid crystal display component according to claim 1, wherein the backlight component comprises an optical film, a plurality of lugs are arranged at intervals around an edge of the optical film, hitch through holes are arranged on the lugs, a plurality of concaved areas are arranged at intervals around an end of the back plate, a bump is arranged in a middle part of each of the concaved areas, the lugs are accommodated in the concaved areas, and the bump is hitched to the respective hitch through hole.

15. The liquid crystal display component according to claim 14, wherein the backlight component comprises the optical film, a diffusion plate and a reflection plate which are sequentially stacked, and lamp beads embedded in the reflection plate, wherein light from the lamp beads are directed to the diffusion plate.

16. The liquid crystal display component according to claim 1, wherein the first end of the frame body is located on one side close to the middle part of the supporting frame, and a guide angle is arranged from the first end of the frame body to the second end of the frame body.

17. The liquid crystal display component according to claim 1, wherein an angle of the guide angle is 15 degrees.

18. A liquid crystal display apparatus, comprising a liquid crystal display component, wherein the liquid crystal display component comprises a supporting frame, a liquid crystal panel, a back plate and a backlight component; wherein
the supporting frame comprises a frame body and a supporting platform, a first end of the frame body surrounds around the back plate and is connected with the back plate, a second end of the frame body extends to a middle part of the supporting frame to form the supporting platform, the liquid crystal panel is overlapped on a supporting surface of the supporting platform, a colloid layer is arranged between the supporting surface of the supporting platform and the liquid crystal panel, an accommodation space is formed between the liquid crystal panel and the back plate, and the backlight component is arranged in the accommodation space and connected with the back plate.

19. A method for manufacturing a liquid crystal display component, which is used for manufacturing the liquid crystal display component, comprising:
positioning a supporting frame by using a mold, and performing a first time of dispensing on a supporting platform at a first end of the supporting frame;
buckling the liquid crystal panel on the supporting platform and bonding the liquid crystal panel with the supporting platform;
performing a second time of dispensing between the liquid crystal panel and a frame body of the supporting frame; and
arranging a backlight component on a back plate, and connecting the back plate with a second end of the supporting frame.

20. The method for manufacturing the liquid crystal display component according to claim 19, further comprising:
providing the supporting frame to be in shape of a rectangular ring and dividing the supporting frame into four line-shaped frames; and
making one end of the supporting platform of each line-shaped frame of the supporting frame away from the frame body support abut against the mold, and pressing the line-shaped frame towards a middle part of the supporting frame to position the supporting frame.
